(19) United States
(12) Patent Application Publication
(10) Pub. No.: US 2010/0089930 A1
(43) Pub. Date: Apr. 15, 2010

(54) PERISHABLES SHIPPING BOX

(76) Inventor: Yaron Cina, Moshav Sarona (IL)

Correspondence Address: David Klein;DEKEL PATENT LTD., Beit HaRof'im, Room 27, 18 Menuha VeNahala Street, REHOVOT, IL

(21) Appl. No.: 12/249,972

(22) Filed: Oct. 13, 2008

(51) Int. Cl. A47J 41/00; B65B 55/00

(52) U.S. Cl. 220/592.21; 426/411

(57) ABSTRACT

A perishables shipping box including a plurality of panels constructed of a foamed material joined with a fabric material, the panels including a cover, four side panels and a bottom panel attached to one another to form a box, wherein for two of the side panels the foamed material has at least one open window and the fabric material is porous including a multiplicity of vent holes such that air flows through the vent holes and the at least one window.

### FIELD OF THE INVENTION

The present invention relates generally to perishables shipping boxes, such as for transporting fresh flowers and the like to different markets.

### BACKGROUND OF THE INVENTION

Many kinds of perishables shipping boxes, packages, containers and the like (the terms being used interchangeably throughout the specification and claims) are known and used in the industry. There are many problems encountered in shipment of perishables, such as cut flowers, foliage, fruits and other agricultural produce (the terms being used interchangeably throughout the specification and claims), so that the goods arrive at their destination in fresh condition after transportation and handling. For example, the perishables must be securely held during shipment to avoid damage thereto. Concerns regarding temperature and aeration (air flow or ventilation) are just some of the many other problems.

### SUMMARY OF THE INVENTION

The present invention seeks to provide a novel perishables shipping box for holding and transporting perishables, as is described more in detail hereinbelow.

There is thus provided in accordance with an embodiment of the present invention a perishables shipping box including a plurality of panels constructed of a foamed material joined with a fabric material, the panels including a cover, four side panels and a bottom panel attached to one another to form a box, wherein for two of the side panels the foamed material has at least one open window and the fabric material is porous including a multiplicity of vent holes such that air flows through the vent holes and the at least one window.

The foamed and fabric materials may be made of identical plastic materials. For example, the foamed and fabric materials may be made of polypropylene. The foamed and fabric materials may be fully recyclable materials.

The foamed material may be constructed of an array of strengthening ribs.

The two side panels with the at least one open window and the vent holes may be parallel to each other.

The fabric material may be joined to just one side or both sides of the foamed material.

The flat weft threads of the fabric material twists upon forced entry of chilled air through the vent holes and twists back upon termination of forced entry of chilled air through the vent holes.

The perishables shipping box may include a securing element that cooperates with a ratchet mechanism mounted on side panels of the box for securing perishables in the box. The securing element may include an elongate bar with a pair of resilient, pivoting clamps at ends of the bar, each of the clamps pivoting about a pivot pin and including a tooth and a release handle, wherein the tooth catches with the ratchet mechanism.

There is also provided in accordance with an embodiment of the present invention a method for shipping perishables in a shipping box including placing perishables in a box that includes a plurality of panels constructed of a foamed material joined with a fabric material, the panels including a cover, four side panels and a bottom panel attached to one another to form the box, wherein for two of the side panels the foamed material has at least one open window and the fabric material may be porous including a multiplicity of vent holes such that air flows through the vent holes and the at least one window.

The method may further include modularly attaching one of the boxes with another of the boxes, and/or modularly attaching additional panels to the box to increase a size of the box.

### BRIEF DESCRIPTION OF THE DRAWINGS

The present invention will be understood and appreciated more fully from the following detailed description, taken in conjunction with the drawings in which:

FIG. 1 is a simplified pictorial illustration of a perishables shipping box, constructed and operative in accordance with an embodiment of the present invention;

FIG. 2 is a simplified pictorial illustration of a panel of the perishables shipping box, showing construction from a foamed material joined with a fabric material, in accordance with an embodiment of the present invention;

FIG. 3 is a simplified illustration of the perishables shipping box of FIG. 1, with cover and bottom panels removed;

FIG. 4 is a simplified illustration of the perishables shipping box of FIG. 3, in a flattened configuration;

FIG. 5 is a simplified exploded illustration of the perishables shipping box of FIG. 3;

FIGS. 6 and 7 are simplified illustrations of another panel of the perishables shipping box of FIG. 1, again showing construction from a foamed material joined with a fabric material, wherein the fabric material is porous to allow air flow therethrough, in accordance with an embodiment of the present invention;

FIG. 8 is a simplified illustration of a portion of a ratchet mechanism for securing the perishables during shipment, in accordance with an embodiment of the present invention;

FIG. 9 is a simplified illustration of the perishables shipping box with securing elements placed in the ratchet mechanism;

FIGS. 10 and 11 are simplified pictorial and partially cutaway illustrations, respectively, of the securing element, in accordance with an embodiment of the present invention;

FIGS. 12 and 13 are simplified pictorial illustrations of two other sizes of perishables shipping boxes, constructed and operative in accordance with other embodiments of the present invention; and

FIG. 14 is a simplified illustration of a locking closure for the cover of the perishables shipping box, constructed and operative in accordance with an embodiment of the present invention.

### DETAILED DESCRIPTION OF EMBODIMENTS

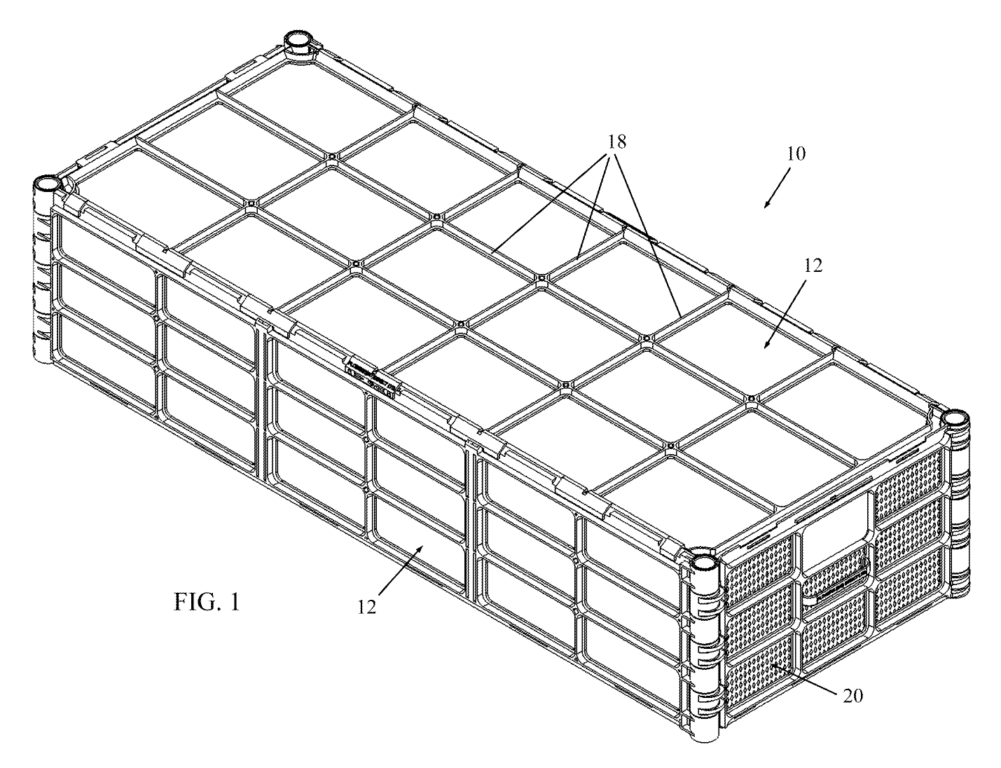

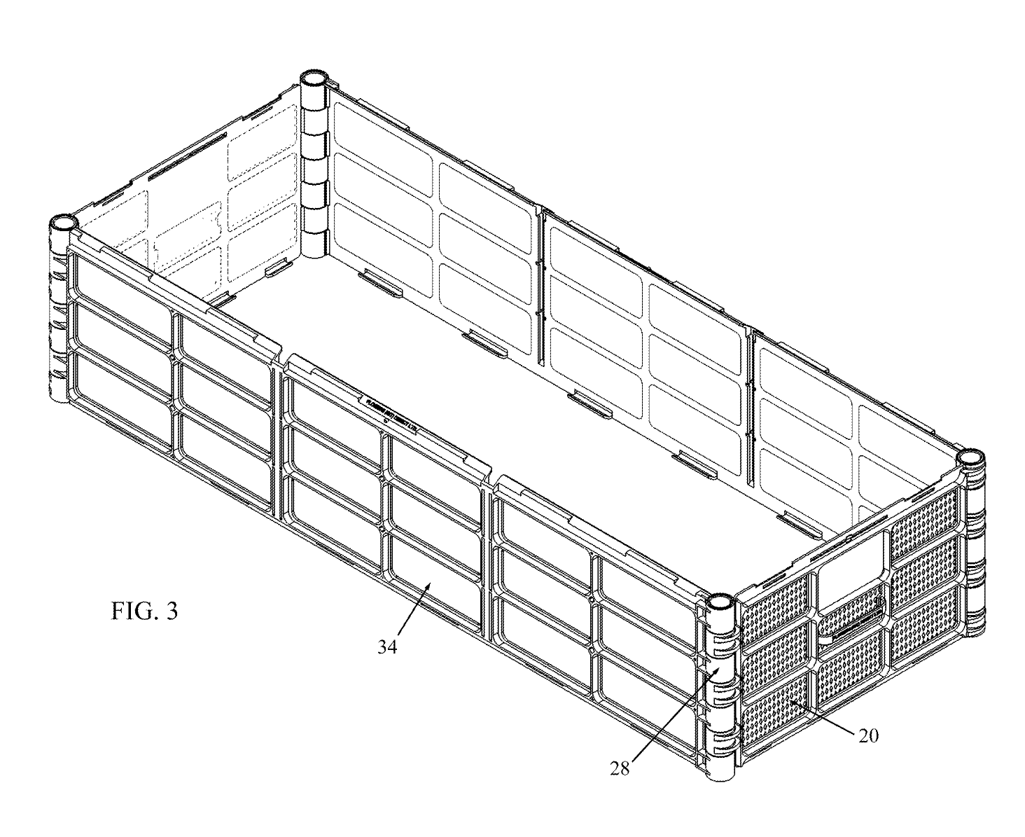

Reference is now made to FIGS. 1-7, which illustrate a perishables shipping box 10, constructed and operative in accordance with a non-limiting embodiment of the present invention.

Perishables shipping box 10 includes a plurality of panels 12 constructed of a foamed material 14 joined with a fabric material 16. For example, the foamed material may be foamed molded polypropylene (PP) and the fabric material may be woven or non-woven PP fabric. The foamed material provides carrying strength for bearing the weight of the box and its contents, whereas the fabric material provides tensile strength to provide stiffness and pulling strength. It is noted that the foamed material and the fabric material can be the same material, e.g., PP, or can be different materials, e.g., foamed polyethylene or polyurethane and PP fabric.

The term “joined” encompasses any method for attaching the foamed material and fabric together, such as but not limited to, in-molding, ultrasonic welding, thermal bonding, adhesive bonding and others. The combination of materials provides a significant reduction in weight over prior art cardboard or carton boxes. Thus, one of the advantages of the present invention over the prior art is significant savings in air freight and handling costs, which are calculated as a function of weight, without compromising on the strength of the box.

Another advantage is the box 10 can be produced from fully recyclable materials, thereby enhancing the “green” factor. The construction can also prevent heating from direct sunlight, when a sun reflecting fabric is used. The box 10 can be re-used many times, thereby reducing costs to the grower per use. The boxes can be conveniently and easily stacked for handling in pallets, thereby providing significant savings in handling, storage and transportation.

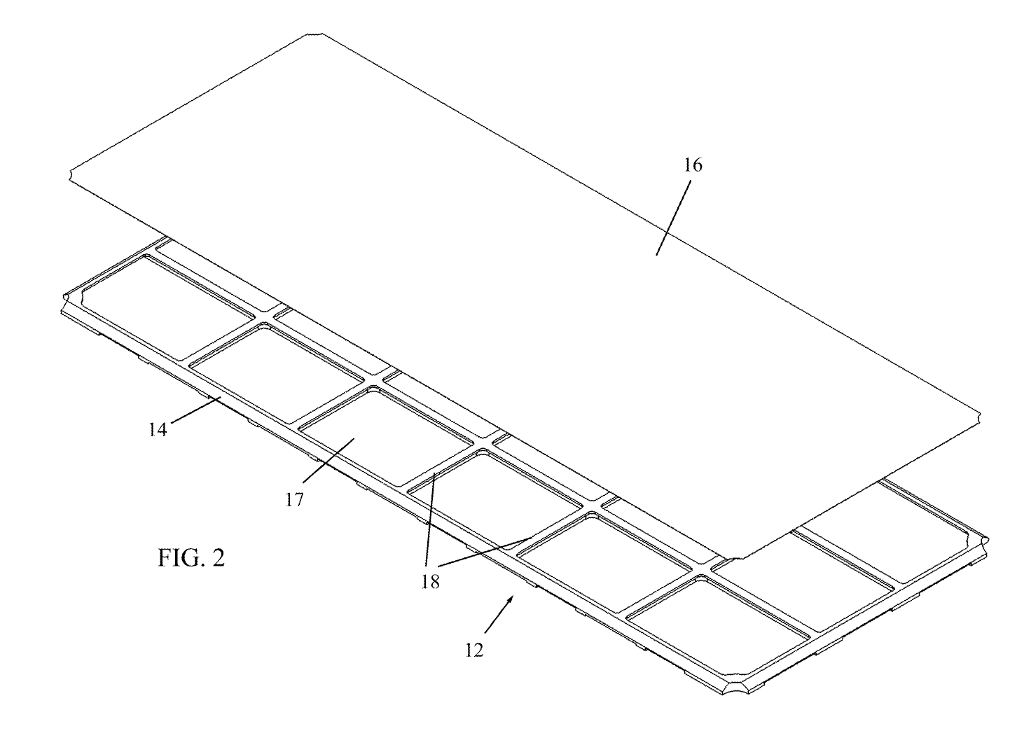

FIG. 2 illustrates a top panel (cover) constructed of foamed material 14 joined with fabric material 16. The foamed material 14 is constructed of a crisscross array of strengthening ribs 18. In one construction, the panel is a relatively thin sheet with the ribs 18 extending along the length and width of the sheet. Alternatively, the ribs 18 border open windows 17, which are covered by the fabric material 16. The fabric material 16 may be joined to just one side of the foamed material 14, or to both sides (forming a sandwich construction). The fabric material 16 is relatively non-porous. This construction is used not just for the cover but also for the long sides and bottom panel of the box in FIG. 1.

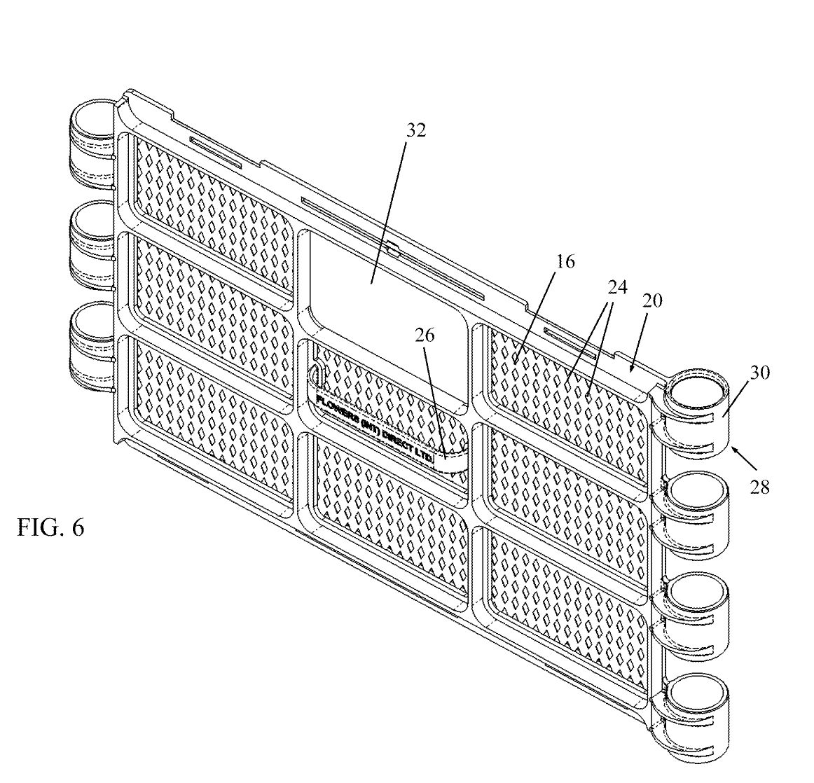

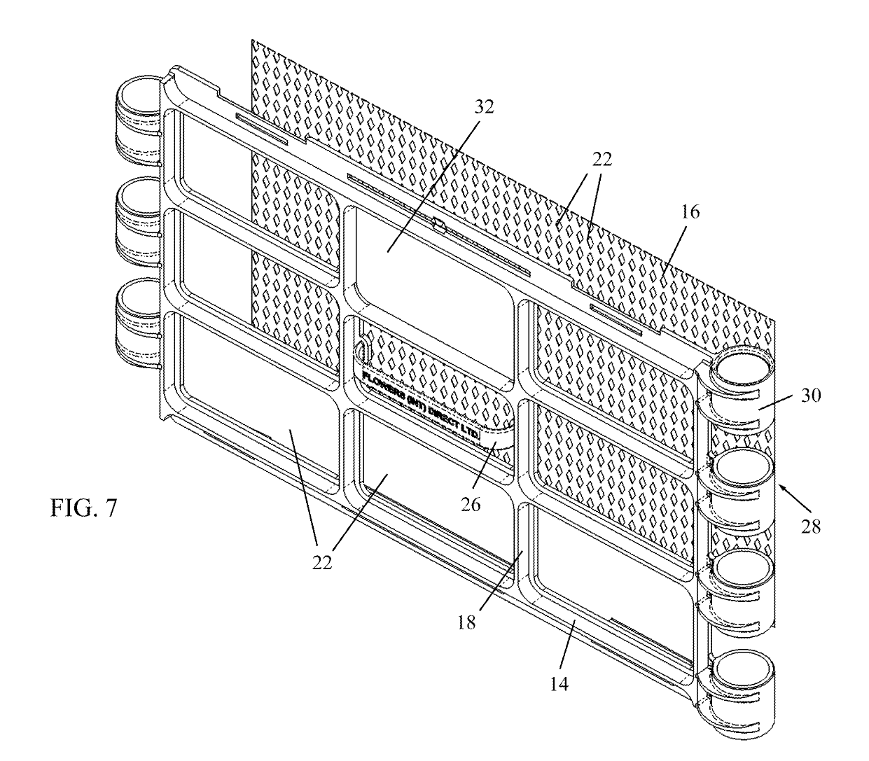

FIGS. 6-7 illustrate an end panel 20 (short sides of the box in FIG. 1), also constructed of foamed material 14 joined with fabric material 16. The foamed material 14 is constructed of a crisscross array of strengthening ribs 18 with open windows 22 bordered by the ribs 18. The fabric material 16 is porous comprising a multiplicity of vent holes 24. The fabric material 16 is joined over the foamed material 14 and the vent holes 24 allow for air flow through the windows 22. One or more windows may be closed (as indicated by reference numeral 32), that is, the foamed material 14 is left between the ribs 18. Again, fabric material 16 may be joined to one or both sides of foamed material 14.

It is noted that in the art of packing and transporting perishables, the perishables are generally cooled to prolong shelf-life. Rapid cooling of perishables is typically used, which involves either forced-air cooling or vacuum cooling or a combination of both. Hot air given off by the perishables is drawn out of the box and fresh, chilled air is introduced into the box. In the prior art, the exchange of hot and cold air flows through holes in the cardboard. In the present invention, the flow is through vent holes 24.

An advantage of the present invention over the prior art is that the flat weft threads of the fabric material 16 tend to twist (that is, the diameter of the vent holes increases) upon forced entry of chilled air (thereby enabling rapid entry of the chilled air), but twist back afterwards (that is, after termination of forced air flow) to make the porosity of the vent holes 24 smaller than the holes of the prior art. The result is that for rapid cooling the total area available for chilled air flow through vent holes 24 is the same as or greater than the area of the holes of the prior art (thereby achieving a rapid time for cooling), but the area is significantly less than the prior art (thereby achieving a longer time for cooling loss) during storage and transportation, thereby prolonging shelf-life.

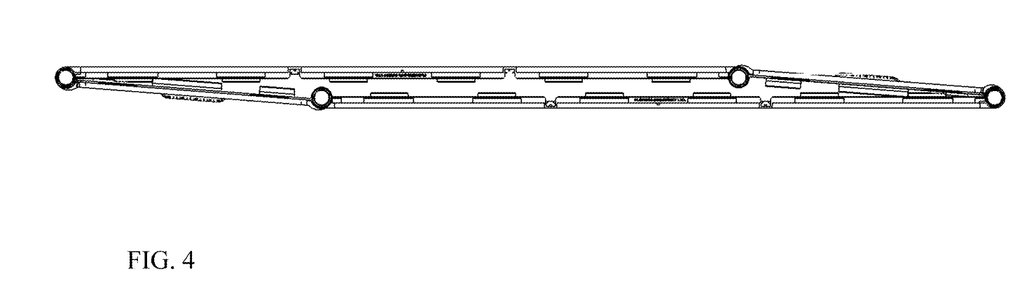

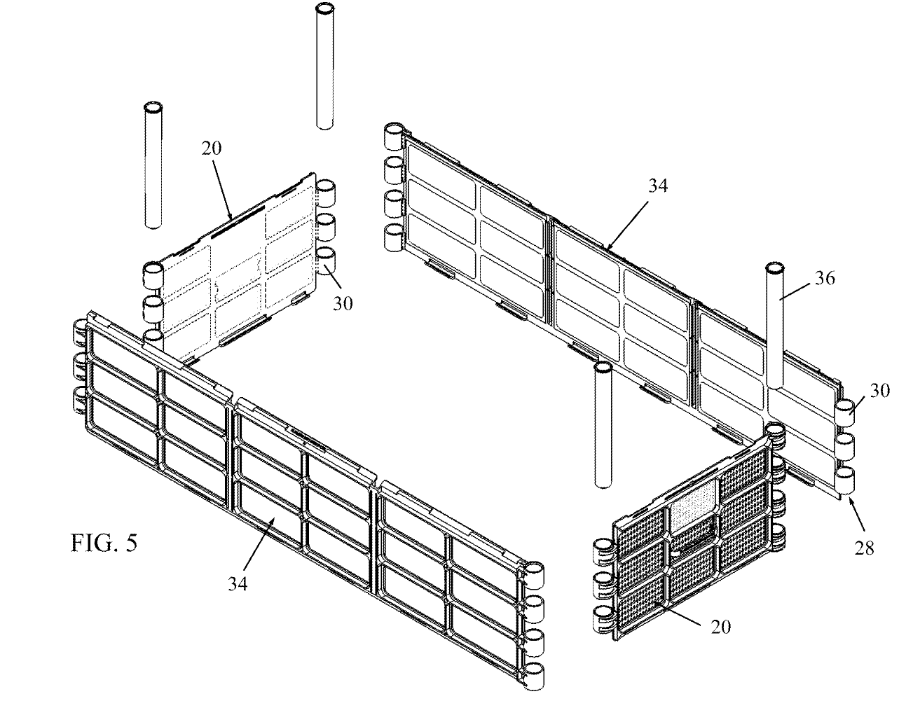

The end panel 20 may include a handle 26, which may be molded as a continuous unitary piece extending from ribs 18. As seen more in detail in FIG. 5, the sides of end panel 20 and of long side panels 34 include joint members 28 for attaching to one another at the corners of the box. The joint members 28 may include one or more hinge sockets 30 vertically aligned with each other with a pin 36 placed through the hinge sockets 30. This construction is modular, which saves on shipping costs, and provides a collapsible box (when there is no top and bottom) as seen in FIG. 4. This construction also protects the box from crushing. The cover and bottom panel may be attached by a snap connection to the four side panels or by fasteners or any other suitable method.

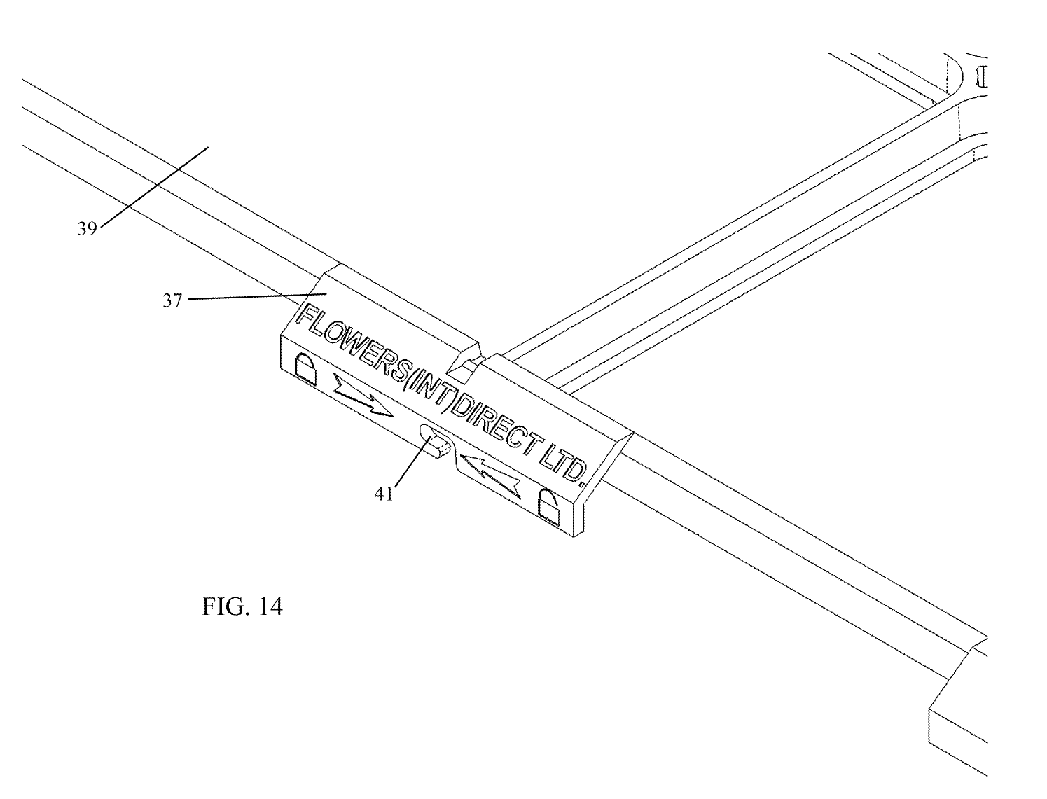

Reference is now made to FIG. 14, which illustrates a locking closure for the cover of the perishables shipping box, constructed and operative in accordance with an embodiment of the present invention.

The locking closure may include a latch 37 that moves (e.g., slides) across an edge or surface of the cover (denoted by numeral 39). The locking closure with the cover does not warp or bend under the effects of temperature or stress. Latch 37 has an L-shaped groove 41 formed therein. Latch 37 has an unlocked position and a locked position, which may be indicated by indicia on the latch (e.g., by arrows and pictures of a lock that is either locked or unlocked, as shown in FIG. 14). In the locked position, latch 37 is moved so that groove 41 snugly and lockingly fits over a protrusion (not seen in FIG. 14) protruding from a top edge of one of the side panels, thus effecting a locked engagement with that protrusion. In the unlocked position, latch 37 is moved out of locked engagement with that protrusion.

A variety of fabrics may be used, such as but not limited to, reflecting material, closely-spaced or loosely-spaced warp and weft threads (to control the amount of air circulation), fire-resistant, moisture resistant and many more. Different colors may be used for grade marking or distinguishing between different perishables. Advertising may be easily printed on or molded into the panels.

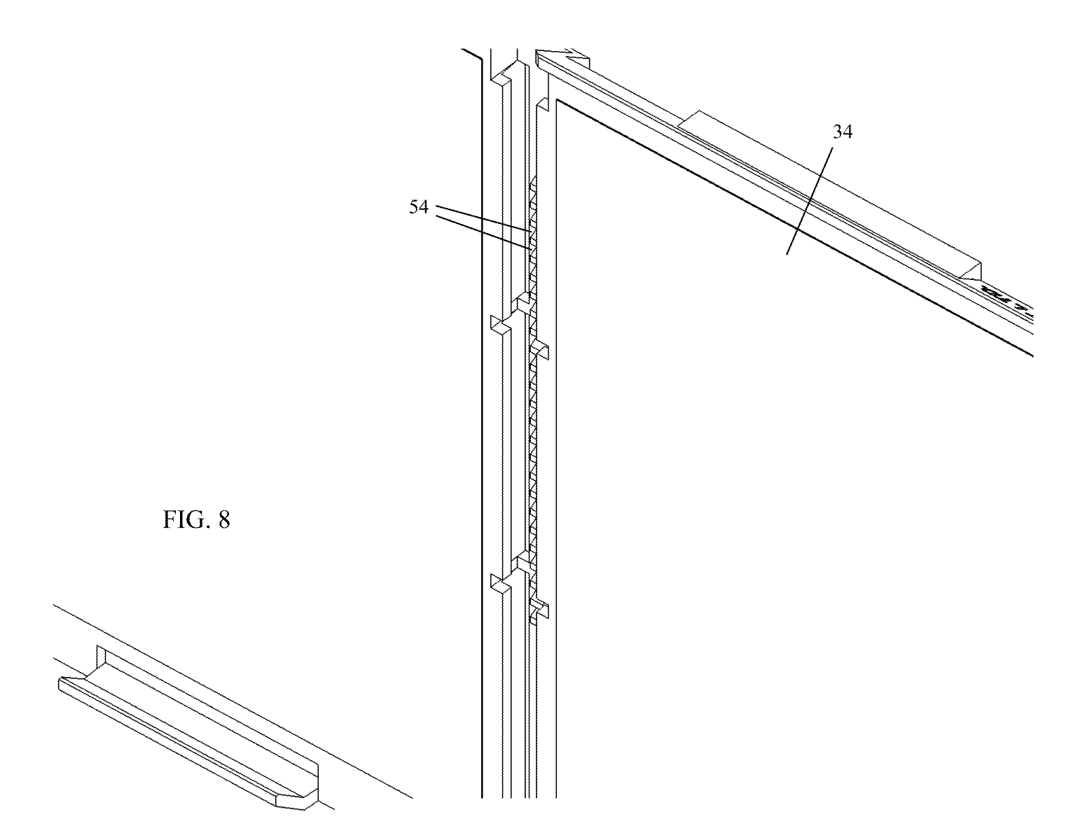

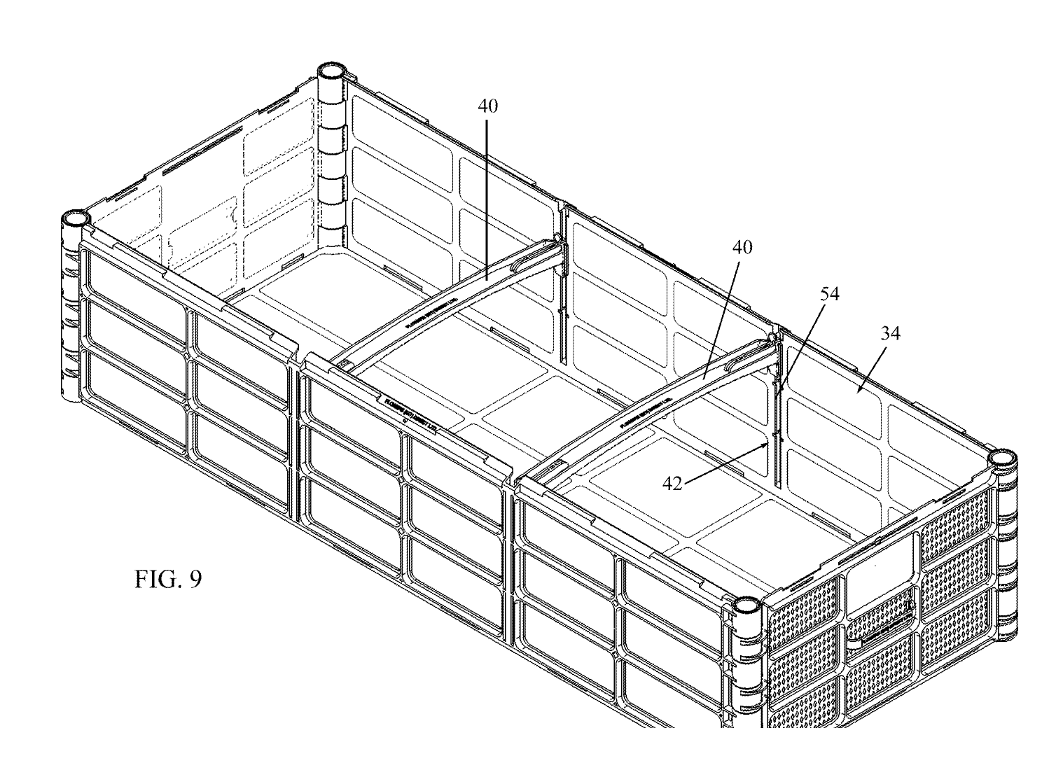

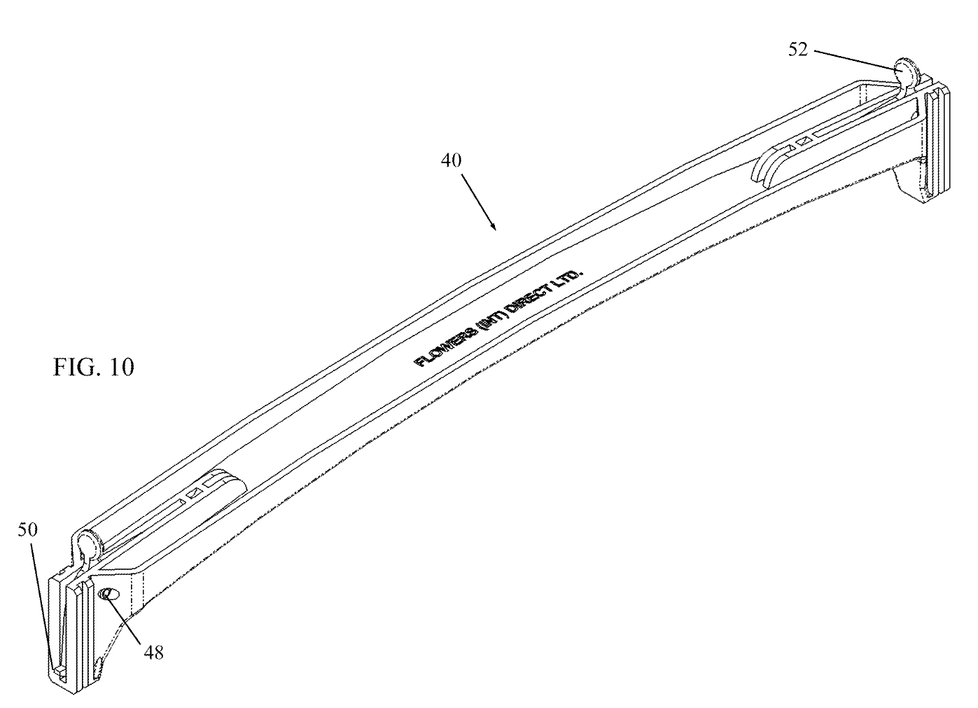

Reference is now made to FIGS. 8-11, which illustrate a securing element 40 that cooperates with a ratchet mechanism 42 for securing the perishables during shipment, in accordance with an embodiment of the present invention.

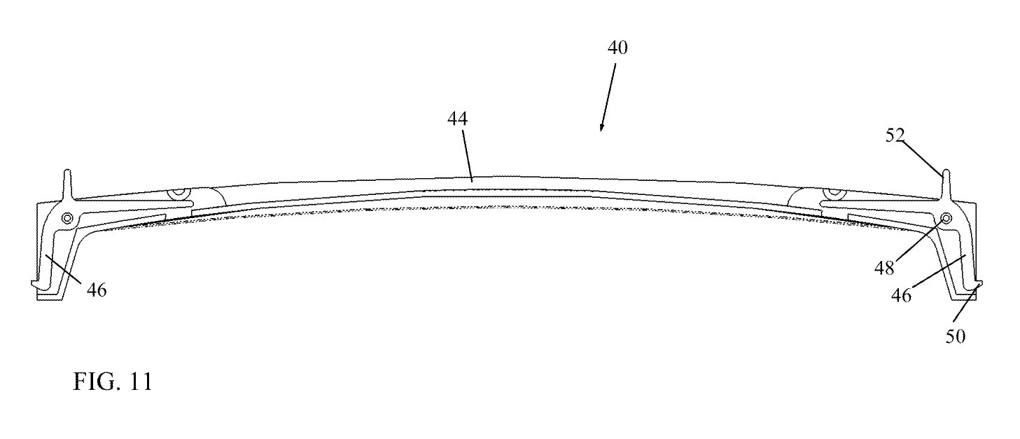

The securing element 40 includes an elongate bar 44 with a pair of resilient, pivoting clamps 46 at ends of the bar 44 (FIG. 11). Clamp 46 pivots about a pivot pin 48 and includes a tooth 50 and a release handle 52 (FIG. 11). The tooth 50 is designed to catch with ratchet mechanism 42, which includes a plurality of female toothed grooves 54 along long side panels 34 (FIG. 8). The securing element 40 is installed in the box 10 by simply placing securing element 40 between opposite and parallel ratchet mechanisms 42, and pushing securing element 40 down so that teeth 50 ratchet with ratchet mechanism 42. In this manner, securing element 40 may be pushed down against the perishables to secure them during shipping. Thus, securing element 40 helps prevent movement of the perishables in box 10 and maintains quality of the perishables. The securing element 40 may be released from ratchet mechanism 42 by pushing release handles 52.

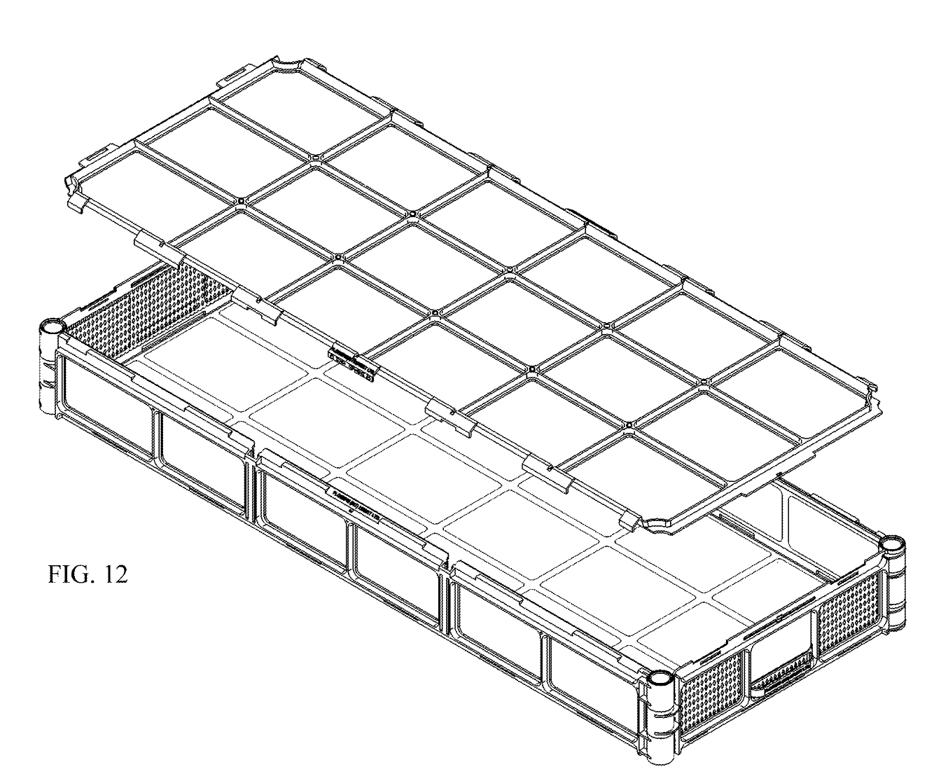

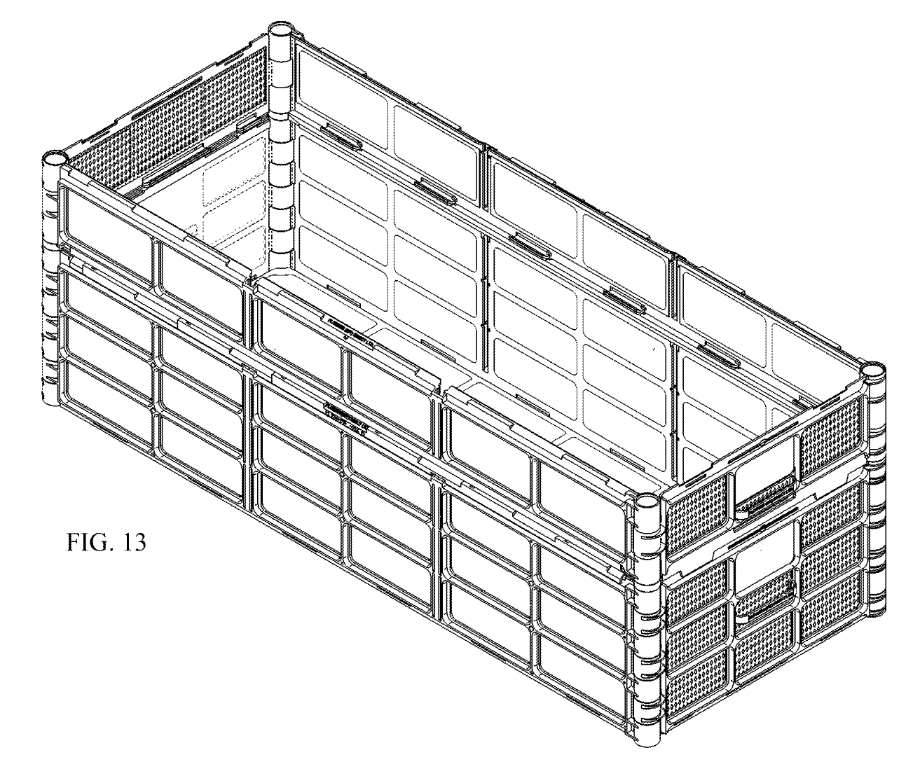

Reference is now made to FIGS. 12 and 13, which illustrate two other sizes of perishables shipping boxes, constructed and operative in accordance with other embodiments of the present invention. Any size box may be constructed due to the modular nature of the panels. The modular packaging system of the invention enables adapting the size of the box to the quantity of perishables ordered.

Additional aspects of the invention include the possibility of adding a lining (joined by any of the above methods) to the exterior of the box to give additional strength and improved insulation without a significant increase in the weight of the box. The use of securing elements 40 may allow the box to be used without a lid, thereby achieving additional weight and costs savings. The modularity of the box enables joining two or three (or more) boxes together side by side, creating a double or triple (or more) box. The assembly can be joined to a special leg attachments, and may serve as a pallet for bulk height saving.

The scope of the present invention includes both combinations and subcombinations of the features described hereinabove as well as modifications and variations thereof which would occur to a person of skill in the art upon reading the foregoing description and which are not in the prior art.

What is claimed is:

1. A perishables shipping box comprising:
a plurality of panels constructed of a foamed material joined with a fabric material, said panels comprising a cover, four side panels and a bottom panel attached to one another to form a box, wherein for two of said side panels said foamed material has at least one open window and said fabric material is porous comprising a multiplicity of vent holes such that air flows through said vent holes and said at least one window.

2. The perishables shipping box according to claim 1, wherein said foamed and fabric materials are made of identical plastic materials.

3. The perishables shipping box according to claim 1, wherein said foamed and fabric materials are made of polypropylene.

4. The perishables shipping box according to claim 1, wherein said foamed and fabric materials are fully recyclable materials.

5. The perishables shipping box according to claim 1, wherein said foamed material is constructed of an array of strengthening ribs.

6. The perishables shipping box according to claim 1, wherein the two side panels with said at least one open window and said vent holes are parallel to each other.

7. The perishables shipping box according to claim 1, wherein said fabric material is joined to just one side of said foamed material.

8. The perishables shipping box according to claim 1, wherein said fabric material is joined to two sides of said foamed material.

9. The perishables shipping box according to claim 1, wherein said fabric material twists upon forced entry of chilled air through said vent holes and twists back upon termination of forced entry of chilled air through said vent holes.

10. The perishables shipping box according to claim 1, wherein one of said side panels comprises a handle.

11. The perishables shipping box according to claim 1, wherein said side panels comprise joint members for attaching to one another at corners of the box.

12. The perishables shipping box according to claim 11, wherein said joint members comprise hinge sockets vertically aligned with each other with a pin placed through said hinge sockets.

13. The perishables shipping box according to claim 1, further comprising a securing element that cooperates with a ratchet mechanism mounted on side panels of said box for securing perishables in said box.

14. The perishables shipping box according to claim 13, wherein said securing element comprises an elongate bar with a pair of resilient, pivoting clamps at ends of said bar, each of said clamps pivoting about a pivot pin and comprising a tooth and a release handle, wherein said tooth catches with said ratchet mechanism.

15. The perishables shipping box according to claim 1, further comprising a locking closure for said cover, wherein said locking closure comprises a latch that moves between an unlocked position and a locked position.

16. A method for shipping perishables in a shipping box comprising:
placing perishables in a box that comprises a plurality of panels constructed of a foamed material joined with a fabric material, said panels comprising a cover, four side panels and a bottom panel attached to one another to form the box, wherein for two of said side panels said foamed material has at least one open window and said fabric material is porous comprising a multiplicity of vent holes such that air flows through said vent holes and said at least one window.

17. The method according to claim 16, further comprising securing said perishables in said box with a securing element that cooperates with a ratchet mechanism mounted on side panels of said box.

18. The method according to claim 16, further comprising modularly attaching one of said boxes with another of said boxes.

19. The method according to claim 16, further comprising modularly attaching additional panels to said box to increase a size of said box.
